(19) United States
(12) Patent Application Publication
(10) Pub. No.: US 2002/0054233 A1
(43) Pub. Date: May 9, 2002

(54) Electronic camera

(75) Inventor: Masahiro Juen, Yokohama-city (JP)

Correspondence Address: OLIFF & BERRIDGE, PLC, P.O. BOX 19928, ALEXANDRIA, VA, 22320, US

(73) Assignee: NIKON CORPORATION

(21) Appl. No.: 09/951,579

(22) Filed: Sep. 14, 2001

Related U.S. Application Data
(63) Continuation of application No. 08/931,455, filed on Sep. 17, 1997, now abandoned.
(60) Provisional application No. 60/040,921, filed on Mar. 27, 1997.

(30) Foreign Application Priority Data
Sep. 17, 1996 (JP) 08-244634

(51) Int. Cl. H04N 5/225

(52) U.S. Cl. 348/372; 348/333.01; 348/333.05

(57) ABSTRACT

A video camera includes a user interface that is used to control the supply of power to different functional portions of the camera. Power is supplied to (or not supplied to) the various functional portions of the camera based on whether a window relating to the functional portion, which is displayed on a display, is selected to be open or closed. The functional portions can include an imaging portion, an image recording portion, an image reproduction portion, a communication portion and an information processing portion, for example.

### RELATED PROVISIONAL APPLICATION

This nonprovisional application claims the benefit of Provisional Application No. 60/40,921, filed Mar. 27, 1997.

### INCORPORATION BY REFERENCE

The disclosure of the following priority application is herein incorporated by reference: Japanese Patent Application No. 8-244634, filed Sep. 17, 1996.

### BACKGROUND OF THE INVENTION

1. Field of Invention

This invention relates to electronic cameras having a display that can be used as a user interface.

2. Description of Related Art

In recent years, with the advances in information processing technology, electronic cameras have become available that are equipped with a display that performs the display of image information, the state of operation of the camera, or the like. For example, some video cameras have displays that can be used as a viewfinder during photography to confirm the subject range.

FIG. 9 is a perspective view of a video camera. This type of video camera includes a control device such as a microprocessor that controls all of the functional portions of the camera. The functional portions of the camera include an imaging portion, an image recording portion, and an image reproduction (or playback) portion, which will be described later. These various functional portions are operated during photography or during reproduction. Power is supplied to the control device and to the monitor 72 when the power switch 70 is placed in either the “playback” mode or in the “recording” mode.

The control device determines whether the power switch 70 is set to recording or playback when power is supplied thereto. When the result of this determination is that switch 70 is set to recording, the control device supplies power from the power source to the imaging portion, which generates the image information, and to the image recording portion, which stores the image information in an image recording medium. Further, the control device commands the imaging portion to start imaging, and displays the image signals generated by the imaging portion on the monitor 72. Furthermore, the control device commands the image recording portion to record the image information created by the imaging portion when image recording has been requested by the user actuating the image recording switch 74 while image signals are displayed on the monitor 72.

On the other hand, the control device supplies power to the reproduction portion, which reads the image information recorded in the image recording medium out of the recording medium when the result of the determination described above is that switch 70 is set to playback. Further, the control device commands the reading out of the image information from the image recording medium to the reproduction portion when playback is requested via actuation of the playback button, and displays the image information read out by the reproduction portion on the monitor 72.

Thus, control is performed of the power by preventing power from being supplied to the reproduction portion during photography (imaging) and by preventing power from being supplied to the imaging portion and to the image recording portion during playback.

A drawback of this video camera is that a separate switch (power control switch 70) must be manually actuated to control the supply of power to the various portions of the camera as described above. Accordingly, it is not possible to control the supply of power to the various portions of the camera using only a user interface on the monitor 72. Since the power control switch 70 must also be actuated, operationality is lowered.

### SUMMARY OF THE INVENTION

An object of the present invention is to provide an electronic camera having increased operationality when selecting between different functional portions of the camera so as to control the supply and the blocking of power from the power source to the different functional portions using windows displayed on a monitor.

According to one aspect of the invention, opening and closing of windows on a monitor, relating to the different functional portions of the camera, also causes the power to be supplied or blocked from being supplied to the functional portions of the camera. When a window relating to a functional portion is open, power is supplied to that portion. When a window relating to a functional portion is closed, power is prevented from being supplied to that functional portion.

One embodiment incorporating this aspect of the invention is a camera including a window opening/closing control means that identifies when a user selection has been made using an input means to perform opening/closing of a first window or of a second window via a display means. A power source control means supplies power from a power source to an imaging means or to an image recording means when the first window is selected to be opened and supplies power from the power source to a reproduction means when the second window is selected to be opened. The power source control means also prevents power from being supplied to the imaging means and to the image recording means when the first window is closed, and prevents power from being supplied to the reproduction means when the second window is closed.

Accordingly, it is not necessary to perform any additional operations to control the supply of the power, because supply or blocking of the power is performed in conjunction with the opening and closing of windows.

Additionally, a third window can be displayed relating to operation of communication means by which the electronic camera communication with external devices. Then, the power source control means supplies power from the power source to the communication means when the third window is selected to be opened, and prevents power from being supplied to the communication means when the third window is closed.

The third window can be used to control an information processing means (in addition to the communication means or instead thereof). The power source control means supplies power from the power source to the communication means and/or to the information processing means when the third window has been selected to be opened, and prevents power from being supplied to the communication means and/or to the information processing means when the third window is closed.

When the third window can be used to control both the communication means and the information processing means, it also is possible to separately control the supply (or blocking) of power to each of these means. A determining means, when the third window has been opened, determines whether the information processing means or the communication means has been selected via the input means. The power source control means supplies power to the communication means or to the information processing means, while preventing power from being supplied to the other, based on the determination made by the determining means when the third window has been opened. Thus, when the third window has been opened, supply of power from the power source to the communication means and to the information processing means is performed independently.

### BRIEF DESCRIPTION OF THE DRAWINGS

The invention will be described in conjunction with the following drawings in which like reference numerals designate like elements and wherein:

FIG. 1 is a high-level functional diagram of a first aspect of the invention;

FIG. 2 is a high-level functional diagram of a second aspect of the invention;

FIG. 3 is a block diagram of a first embodiment of the invention;

FIG. 4 is an operational flow chart of the first embodiment of the invention;

FIGS. 5A and 5B show examples of a monitor display, with FIG. 5A showing three icons for three closed windows, and FIG. 5B showing the display when a camera window is open;

FIGS. 6A and 6B show additional examples of the monitor display, with FIG. 6A showing the display when a disk window is open, and FIG. 6B showing the display when a portable terminal window is open;

FIG. 7 is a block diagram of a second embodiment of the invention;

FIG. 8 is an operational flow chart of the second embodiment of the invention; and

FIG. 9 is a perspective view of a video camera.

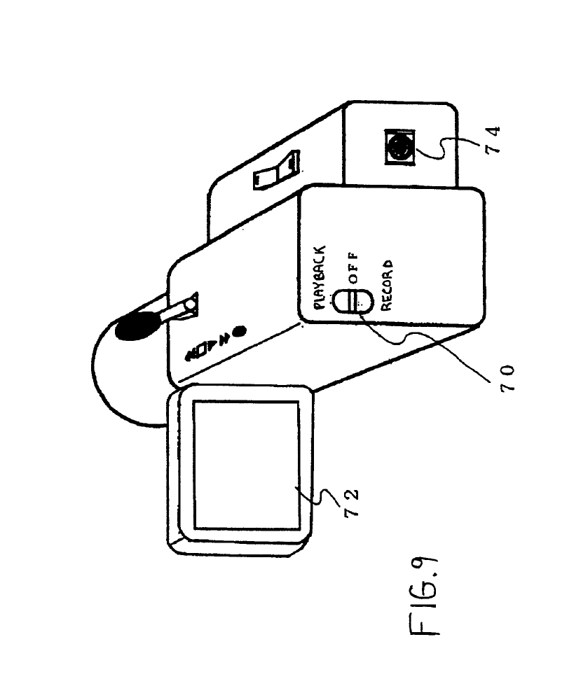

### DETAILED DESCRIPTION OF PREFERRED EMBODIMENTS

Preferred embodiments of the present invention are described below in detail with reference to the drawings.

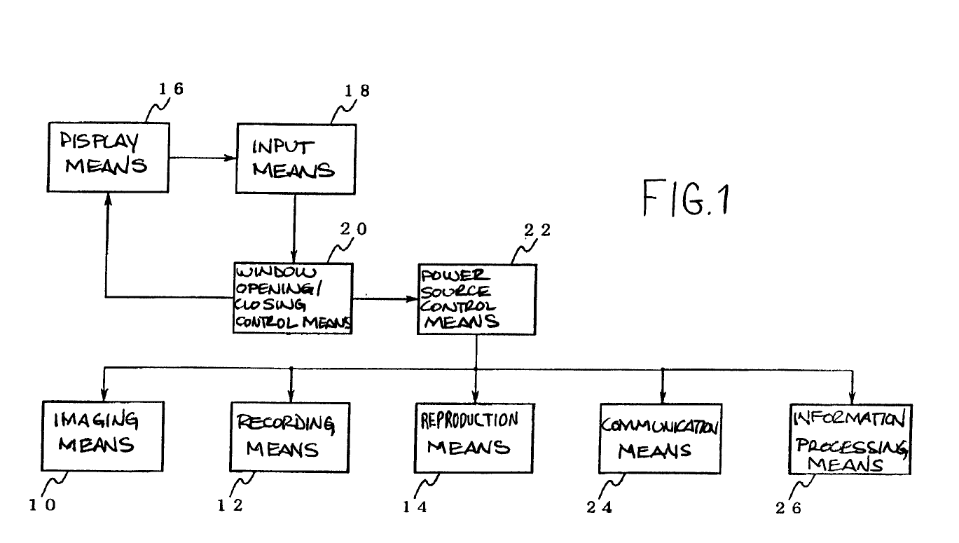

FIG. 1 is a high-level representation of one aspect of the invention. An electronic camera includes a number of functional portions or sub-sections, referred to in FIG. 1 as “means.” As will become clear from the ensuing description, each means is not necessarily a separate or separable unit or component of the camera. There can be overlap between the actual structure and software of the camera that performs (or corresponds to) the various means. For example, a single microprocessor can function as parts of (or all of) more than one of the illustrated means. Alternatively, it is possible to use separate, dedicated microprocessors for each means that relies on microprocessor control.

An imaging means 10 images an object to generate image information. An image recording means 12 records the image information generated by the imaging means 10 in an image recording medium. A reproduction means 14 reads the image information recorded in the image recording medium out of the recording medium. A display means 16 displays, based on a predetermined window system, a plurality of windows. A first window relates to the imaging means 10 and to the image recording means 12. A second window relates to the reproduction means 14. An input means 18 allows a user to specify opening/closing commands relative to these windows. A window opening/closing control means 20 receives the command (or selection) input via the input means 18, and performs opening and closing of the first window and the second window through the display means 16, based on the command. A power source control means 22 supplies power from a power source to the imaging means 10 and to the image recording means 12 when the first window has been selected to be opened via the window opening/closing control means 20. Alternatively, the power source control means 22 supplies power from the power source to the reproduction means 14 when the second window has been selected to be opened. The power source control means 22 also prevents the power from being supplied to the imaging means 10 and to the image recording means 12 when the first window is closed, and prevents the power from being supplied to the reproduction means 14 when the second window is closed.

The electronic camera also can include a communication means 24 that allows for communication between the camera and external devices. For example, communication means 24 can perform transmission to external devices of the image information generated by the imaging means 10 (or reproduced from the image recording medium), or can perform reception of image (or other) information transmitted from external devices. The display means 16 can display a third window relating to the communication means 24. The window opening/closing control means 20 then performs opening/closing of the third window, and the power source control means 22 supplies power to the communication means 24 when the third window has been selected to be opened, and prevents power from being supplied to the communication means 24 when the third window has been closed.

As a further option, the electronic camera also can include an information processing means 26 that performs information processing of information supplied from external devices. The third window displayed by the display means 16 shows the state of the information processing means 26 while displaying the state of the communication means 24. It also is possible for the third window to only display information relating to the information processing means 26. The power source control means 22 supplies power from the power source to the information processing means 26 when the third window has been opened, and prevents power from being supplied to the information processing means 26 when the third window has been closed.

Thus, according to one aspect of the invention, a video camera includes a user interface that is used to control the supply of power to different functional portions of the camera. Power is supplied to (or not supplied to) the various functional portions of the camera based on whether a window relating to that functional portion, which is displayed on a display, is selected to be open or closed.

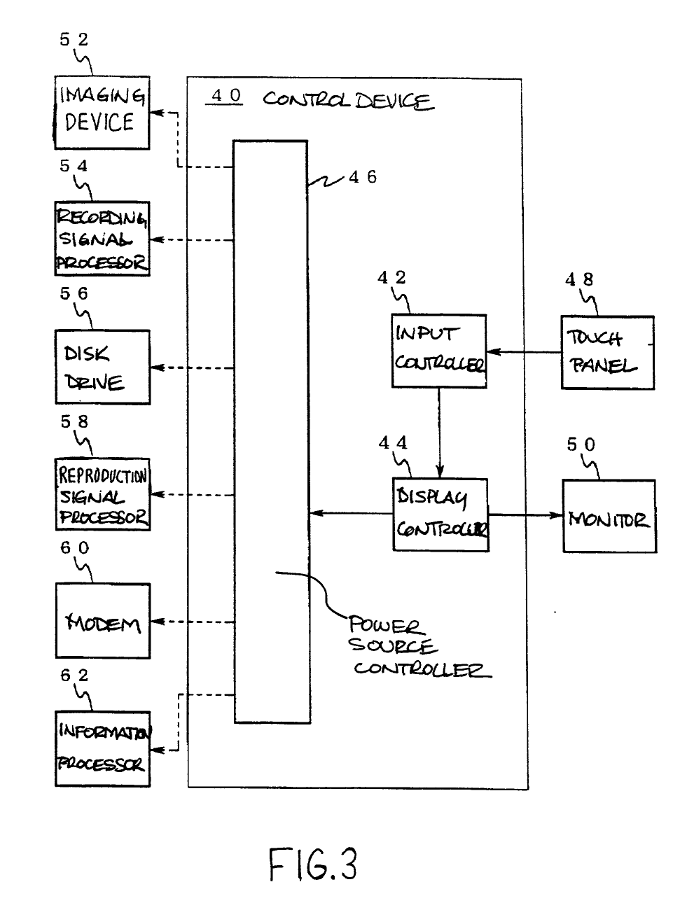

FIG. 3 is a block diagram of a first embodiment relating to this first aspect of the invention.

A control device 40 includes an input controller 42, a display controller 44, and a power source controller 46. A touch panel 48 is connected to an input of the input controller 42. The display controller 44 is connected to an output of the input controller 42. The display controller 44 includes two outputs. A monitor 50 is connected to one of the outputs, and the power source controller 46 is connected to the other output. The monitor can be an LCD display, other flat screen displays, or a CRT, for example. The output of the power source controller 46 is connected to an imaging device 52 (e.g., a CCD), an image recording signal processor 54, a disk drive 56, a reproduction signal processor 58, a modem 60, and an information processor 62, respectively.

The FIG. 3 embodiment relates to the high-level representation shown in FIG. 1 as follows. The input controller 42 and the touch panel 48 function as the input means 18. The display controller 44 functions as the window opening/closing control means 20. The power source controller 46 functions as the power source control means 22. The monitor 50 functions as the display means 16. The imaging device 52 functions as the imaging means 10. The image recording signal processor 54 and the disk drive 56 function as the image recording means 12. The reproduction signal processor 58 and the disk drive 56 function as the reproduction means 14. The modem 60 functions as the communication means 24. The information processor 62 functions as the information processing means 26. The various means are not limited to these structures, which only relate to one possible implementation of the invention.

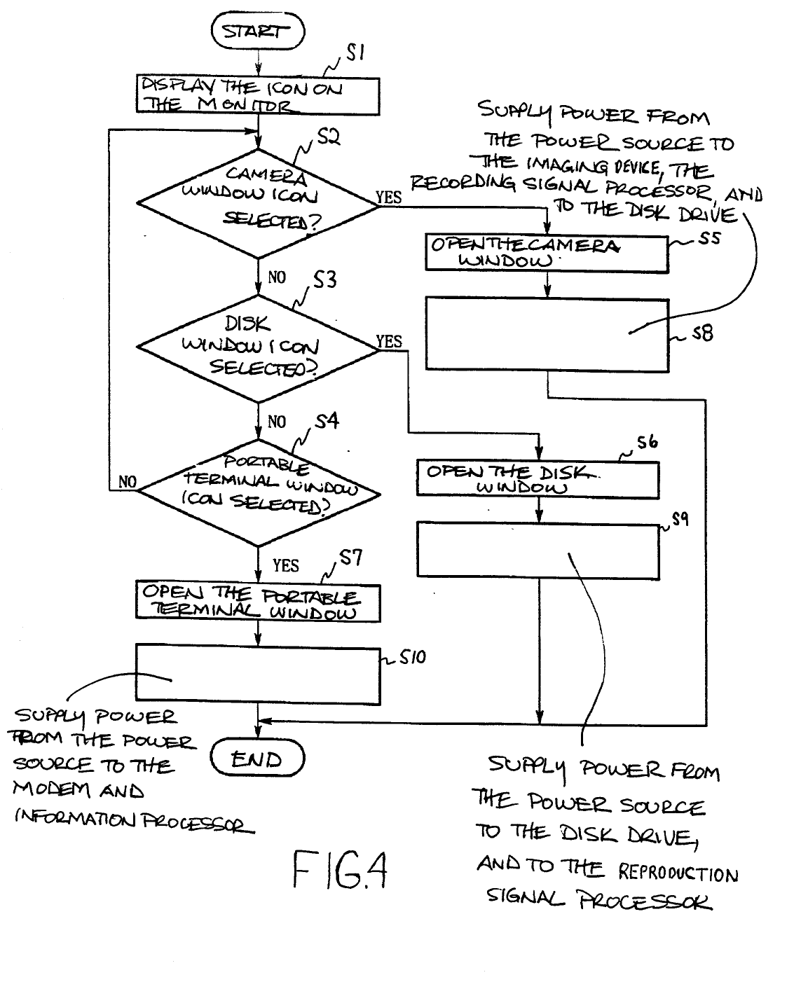

FIG. 4 is an operational flow chart of the FIG. 3 embodiment. The operation of the first embodiment is described below with reference to FIGS. 3 and 4.

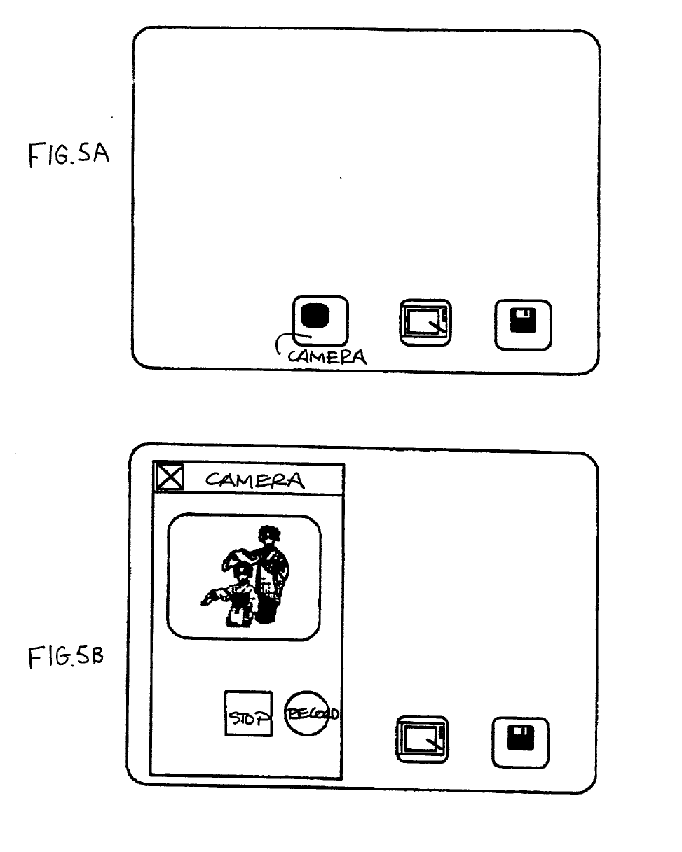

When the main power has been turned on and power has been supplied from the power source to the touch panel 48 and the monitor 50, the display controller 44 displays a number of icons on the monitor 50 as shown in FIG. 5A. These icons can be used to open and close various windows on monitor 50. Referring to FIG. 5A, the left-most icon opens and closes a “camera window,” which is opened during photography (which, in addition to imaging and recording live images, can also include recording images from a floppy disk, hard disk, or the like to the image recording medium). The right-most icon in FIG. 5A opens and closes a “disk window,” which is opened during an operation, such as reproduction or editing, which requires data to be read from the image recording medium. The other icon opens and closes a “portable terminal window,” which is opened during an operation that performs communication or information processing using a portable terminal. The act of displaying these icons is performed in step S1 of FIG. 4.

The input controller 42 continuously monitors the touch panel 48 to determine whether the camera window icon, the disk window icon, or the portable terminal window icon has been selected to open that window (steps S2-S4). The input controller 42: (a) notifies the display controller 44 that the window to be opened (or displayed) is the camera window when the icon for the camera window has been selected as the result of this determination; (b) notifies the display controller 44 that the window to be opened and displayed is the disk window when the icon for the disk window has been selected; and (c) notifies the display controller 44 that the window to be displayed is the portable terminal window when the icon for the portable terminal window has been selected.

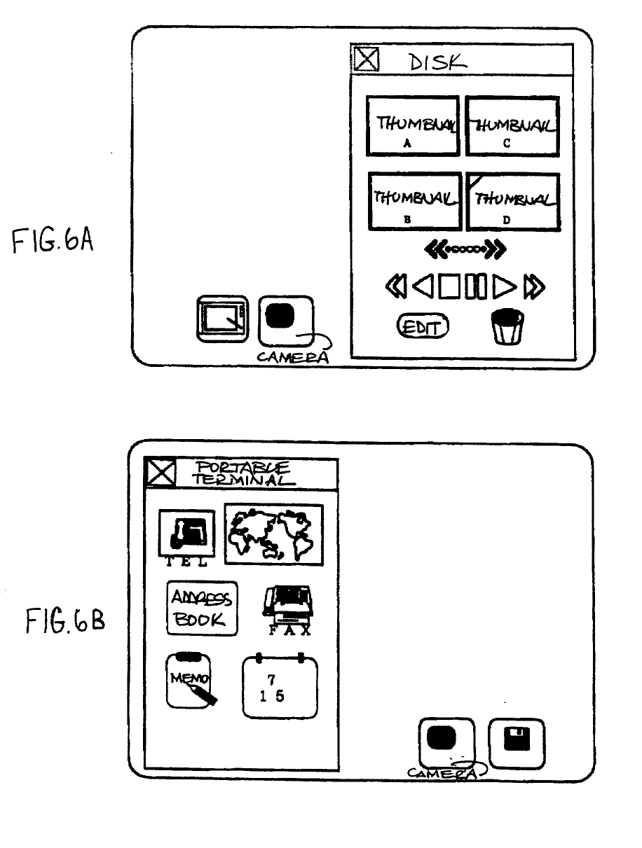

The display controller 44, in conjunction with opening the camera window as shown in FIG. 5B via the monitor 50 when notified to display the camera window by the input controller 42 (step S5), also notifies the power source controller 46 of this determination (or selection). In conjunction with opening the disk window as shown in FIG. 6A via the monitor 50 when notified to display the disk window (step S6), the display controller 44 notifies the power source controller 46 of this selection. When notified to open the portable terminal window, the display controller 44, in conjunction with opening and displaying the portable terminal window as shown in FIG. 6B via the monitor 50 (step S7), notifies the power source controller 46 of this selection.

The power source controller 46 supplies electrical power from the power source to the imaging device 52 (e.g., a CCD), the image recording signal processor 54, and the disk drive 56, when notified by the display controller 44 that the camera window has been opened (step S8). The power source controller 46 supplies power from the power source to the disk drive 56 and to the reproduction signal processor 58 when notified that the disk window has been opened (step S9). Further, the power source controller 46 supplies power from the power source to the modem 60 and to the information processor 62 when notified that the portable terminal window has been opened (step S10).

When the camera window, the disk window, or the portable terminal window are being displayed in this way via the monitor 50, the input controller 42 continues to monitor the status of the touch panel 48. This is done to determine whether a box on the system bar, which is the user-selectable element that closes the windows, has been selected. When this occurs, the input controller 42 notifies the display controller 44 of this fact. The display controller 44, in conjunction with closing the window based on the determination performed by the input controller 42, notifies the power source controller 46 of this fact. The power source controller 46 then prevents the power from being supplied to one or more of the various portions of the camera that correspond to the closed window, when notified by the display controller 44 of the fact that the window has been closed. However, power is only prevented from being supplied to the disk drive 56 when both the camera window and the disk window have been closed.

Accordingly, power is supplied from the power source to respective functional portions of the camera only when it has become possible to provide commands to each functional portion by the user opening the camera window, the disk window, or the portable terminal window.

Therefore, electrical power from the power source is saved, as compared to the case in which power from the power source is supplied to all of the functional portions simultaneously when the main power is turned ON.

Various formats (visual layouts) may be utilized for opening/closing the windows, or for receiving input from the user as long as the user interface is reliably performed. For example, the window opening/closing command can be received via the touch panel 48 by a user touching an icon or a box displayed on the system bar. Alternatively, the window opening/closing command can be received by selecting from a menu display using a position input device such as a mouse.

Further, in this embodiment the power in an electronic camera having a portable terminal function connector is controlled by supplying power to the modem 60 and to the information processor 62 when the portable terminal window has been opened. However, the present invention is not limited to an electronic camera in which only these functions are provided. It is possible to control the power from the power source for an electronic camera having any functional portions, as long as the function is realized by a functional portion that has previously been made to correspond to a window.

Furthermore, in this embodiment a plurality of windows being open at the same time has not been shown for the sake of simplicity. However, it is also possible to supply power from the power source to the imaging device 52, the image recording signal processor 54, the disk drive 56 and the reproduction signal processor 58 when, for example, the camera window and the disk window are opened by an overlapping type of multi-window system in an electronic camera in which photography and editing of image information are performed in parallel.

Further, in this embodiment the only user-selected operation that has been shown is closing a window that has been opened. However, it is also possible to perform other user-selected operations if they can reliably be used to control the window opening/closing operation. For example, in a camera window in which the image information corresponding to the viewfinder is displayed during imaging, and an image recording button and a STOP button are displayed as user-selectable elements, the starting or stopping of image recording is recognized upon user selection of these buttons.

Furthermore, in this embodiment a window is closed when a specific close command is made by a user-selected operation. However, it is also possible, for example, to prevent power from being supplied to a functional portion when a window (for that functional portion) is closed when no user-selected operations have been performed within a predetermined time period while the window is open.

FIG. 22 is a high-level representation of a second aspect of the invention.

An electronic camera similar to the first aspect of the invention also is equipped with a determining means 28 that determines whether the user selection received by the input means 18 is a selection of the information processing means 26, or of the communication means 24. The power source control means 22, based on the determination made by the determining means 28, supplies power from the power source to the communication means 24 when the user selects the communication means 24, and supplies power from the power source to the information processing means 26 when the user selects the information processing means 26. When the communication means 24 is selected, power is prevented from being supplied to the information processing means 26 and vice versa.

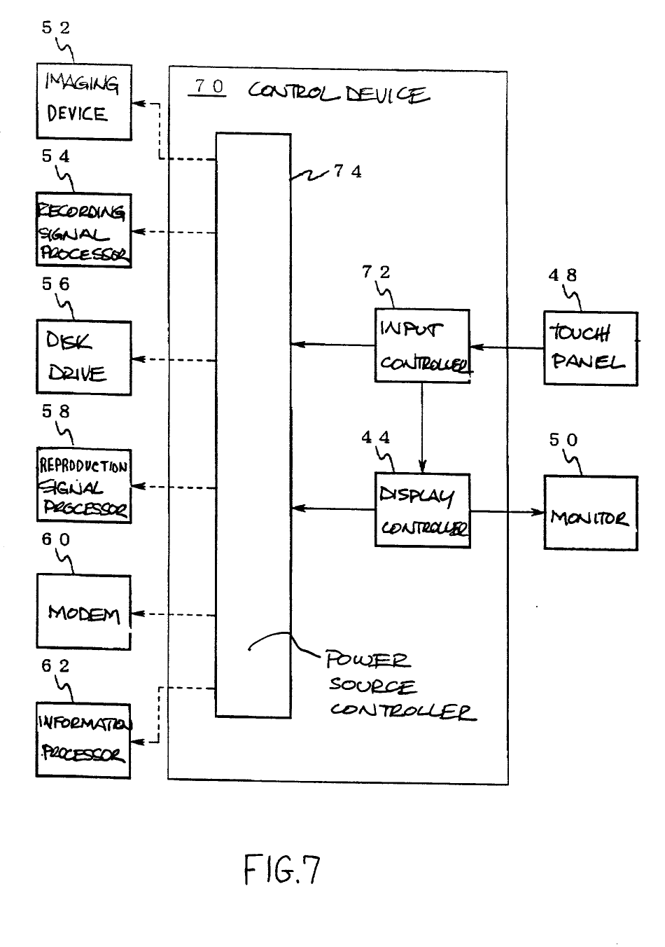

FIG. 7 is a block diagram of a second embodiment of the invention, which relates to this second aspect of the invention. The functions and structures that are the same as in the first embodiment are denoted by the same reference numerals, and an explanation of these functions and structures is omitted here. The points of difference between the structure of this embodiment and the structure of the first embodiment are that a control device 70 is provided in place of the control device 40, the input controller 72 has two outputs, and a power source controller 74 is provided that is connected to one of the output terminals of the input controller 72.

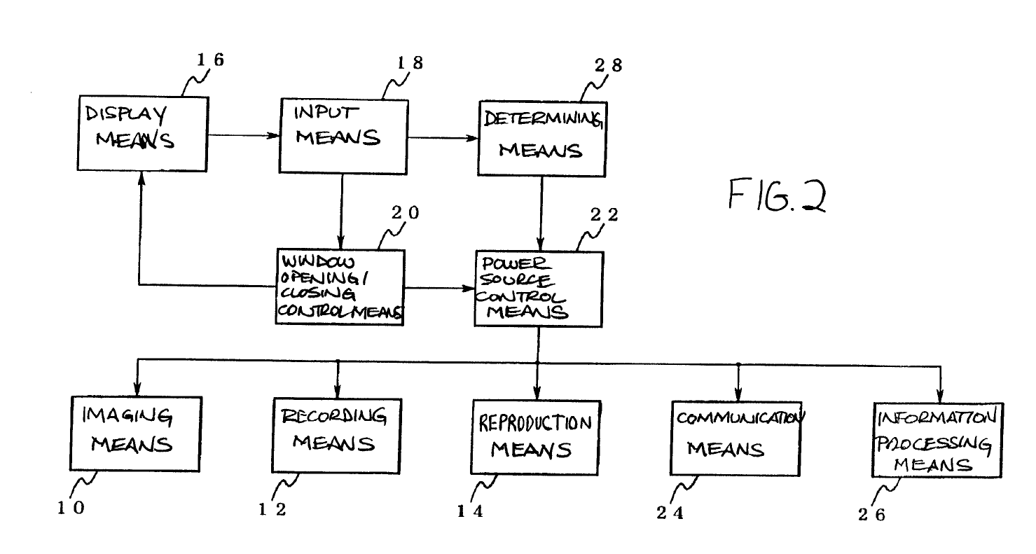

The second embodiment relates to the FIG. 2 high-level representation as follows. The input controller 72 and the touch panel 48 function as the input means 18 and the determining means 28. The display controller 44 functions as the window opening/closing control means 20. The power source controller 74 functions as the power source control means 22. The monitor 50 functions as the display means 16. The imaging device 52 functions as the imaging means 10. The image recording signal processor 54 and the disk drive 56 function as the image recording means 12. The reproduction signal processor 58 and the disk drive 56 function as the reproduction means 14. The modem 60 functions as the communication means 24. The information processor 62 functions as the information processing means 26.

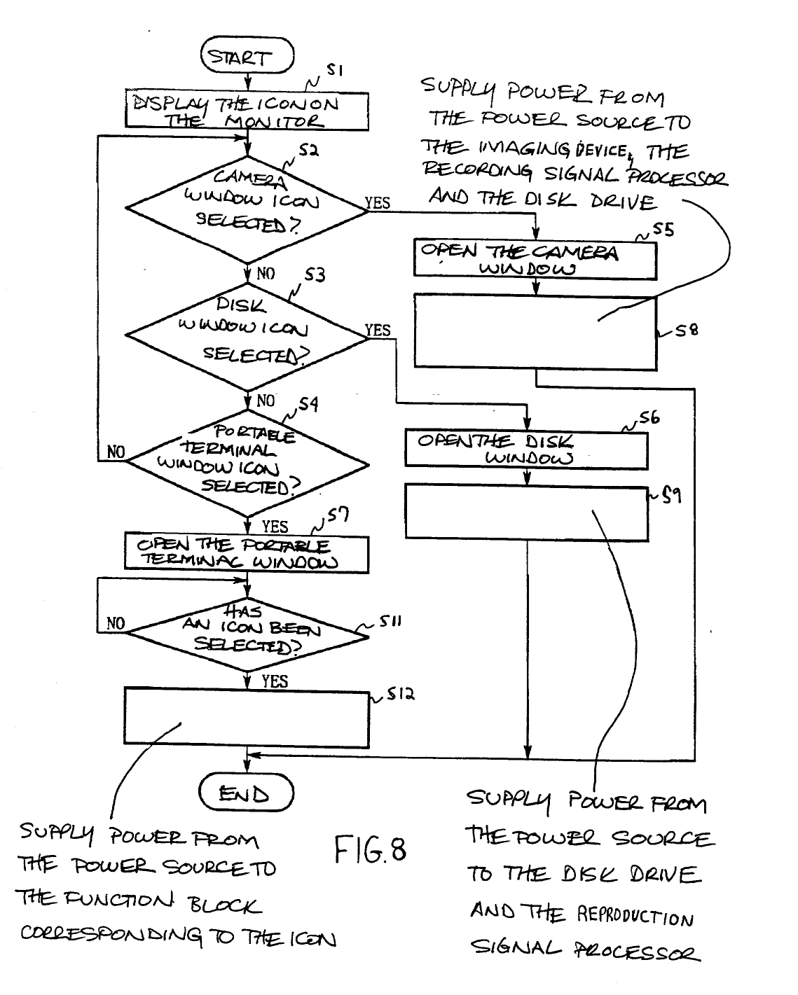

FIG. 8 is an operational flow chart of the second embodiment. In the figure, processes that are the same as the processes shown in FIG. 4 are denoted by the same numbers, and an explanation of these processes is omitted here. The operation of the second embodiment of the invention is described below with reference to FIGS. 7 and 8.

The power from the power source controller 74 is supplied only to the modem 60 and to the information processor 62 when notified by the display controller 44 that the portable terminal window has been opened. The input controller 72 continuously monitors the touch panel 48 when the portable terminal window has been opened, as shown in FIG. 6B, via the monitor 50. In conjunction with determining whether an icon, which is a user selectable element, has been selected (step S1), the input controller 72 performs an identification as to which icon has been selected. Further, the input controller 72 notifies the power controller 74 of the result of this identification. When the portable terminal window is opened, a process (for example, communication, information processing, or the like) that has been predetermined to correspond to an icon can be performed by selecting the icon shown on the portable terminal window. The power source controller 74 supplies power from the power source to the modem 60 or to the information processor 62, which are functional portions corresponding to different icons, when notified by the input controller 72 that the icon has been selected (step S12). Thus, in this embodiment, even when the portable terminal window is open, power is not supplied to the modem 60 when there is no ongoing communication such as by telephone or facsimile; power is supplied only when some communication is proceeding. Also, power is not supplied to the information processor 62 when there is no ongoing information processing such as making a change in an address book; power is supplied only when information processing is proceeding.

Therefore, even more power is saved in the use of an electronic camera as a portable terminal, as compared to when power is supplied simultaneously to both the modem 60 and the information processor 62 when the portable terminal window is opened.

In this embodiment, the blocking of power to the modem 60 or to the information processor 62 can be determined based on the closing of a window or by the occurrence of other events such as, e.g., upon notification to the power source controller 74 by the modem 60 or by the information processor 62 that communication or information processing has ended.

As described above, according to embodiments of the invention, there is no need to perform a specific operation requesting control of the power from the power source (e.g., no need to manually activate switch 70), because the supply and preventing of power is performed to the imaging means and to the image recording means in an operation that is linked with the opening and closing of the first window; and the supply and preventing of power is performed to the reproduction means in an operation that is linked with the opening and closing of the second window.

Furthermore, when applied to a communication function, there is no need to again perform the operation requesting control of the power, because the supply and preventing of power to the communication means is performed in an operation that is linked with the opening and closing of the third window, in the same way as with the first window or the second window.

When applied to an information processing function, there is no need to again perform the operation requesting control of the power, because supply and preventing of power are performed to the information processing means in addition to the communication means in an operation that is linked with the opening/closing of the third window.

Thus, in an electronic camera incorporating these aspects of the invention, electrical power is saved, without any loss of the operationality of the camera because control of the supply and preventing of power is performed to each functional portion in unison with opening and closing of the window, which is performed in a single user selection in a window system.

While this invention has been described in conjunction with specific embodiments thereof, it is evident that many alternatives, modifications and variations will be apparent to those skilled in the art. Accordingly, the preferred embodiments of the invention set forth herein are intended to be illustrative, not limiting. Various changes may be made without departing from the spirit and scope of the invention as defined in the following claims.

What is claimed is:

1. An electronic camera comprising:
imaging means for generating image information from an image of an object;
reproduction means for reading image information recorded in an image recording medium out of the image recording medium;
display means for displaying a first window relating to the imaging means, a second window relating to the reproduction means, and user selection elements by which a user can select opening and closing of the first and second windows;
input means for inputting a selection command relating to the user selection elements;
window opening/closing control means for opening and closing the first window and the second window on the display means based on the input selection command; and
power source control means for supplying power to the imaging means when the first window has been selected to be opened, supplying power to the reproduction means when the second window has been selected to be opened, preventing power from being supplied to the imaging means when the first window is closed, and preventing power from being supplied to the reproduction means when the second window is closed.

2. The electronic camera of claim 1, further comprising:
communication means for communicating with external devices by transmitting the image information generated by the imaging means to the external devices, and receiving information transmitted from the external devices; and wherein:
the display means displays a third window relating to the communication means;
the window opening/closing control means opens and closes the third window; and
the power source control means supplies power to the communication means when the third window has been selected to be opened, and prevents power from being supplied to the communication means when the third window is closed.

3. The electronic camera of claim 2, further comprising:
information processing means for performing information processing of information supplied from the external devices; and wherein:
the third window displayed by the display means also relates to the information processing means; and
the power source control means supplies power to the information processing means when the third window has been selected to be opened, and prevents power from being supplied to the information processing means when the third window is closed.

4. The electronic camera of claim 1, further comprising:
information processing means for performing information processing of information; and wherein:
the display means also displays a third window relating to the information processing means; and
the power source control means supplies power to the information processing means when the third window has been selected to be opened, and prevents power from being supplied to the information processing means when the third window is closed.

5. The electronic camera of claim 1, further comprising:
communication means for communicating with external devices by transmitting information to the external devices and by receiving information transmitted from the external devices;
information processing means for performing information processing of information; and wherein:
the display means displays a third window relating to the communication means and to the information processing means, and also displays user selection elements by which the communication means and the information processing means can be selected;
the window opening/closing control means opens and closes the third window; and
the power source control means supplies power to the communication means when the user selection element for the communication means is selected, and supplies power to the information processing means when the user selection element relating to the information processing means is selected, the power source control means preventing power from being supplied to the communication means and to the information processing means when their respective user selection elements are not selected.

6. The electronic camera of claim 1, further comprising:
image recording means for recording the image information generated by the imaging means in the image recording medium; and wherein:
the first window also relates to the image recording means; and
the power source control means supplies power to the image recording means when the first window is selected to be opened, and prevents power from being supplied to the image recording means when the first window is closed.

7. An electronic camera comprising:
a photoelectric converter that generates image information from an image of an object;
an information reading device that reads image information recorded in an image recording medium out of the image recording medium;
a window generator that generates, for display on a display, a first window relating to an operation performed by the photoelectric converter, a second window relating to an operation performed by the information reading device, and user selection elements by which a user can select opening and closing of the first and second windows;
an input device by which the user selection elements can be selected;
a window controller that controls opening and closing of the first window and of the second window based on the selection of the user selection elements by the input device; and
a power source controller that supplies power to the photoelectric converter when the first window has been selected to be opened, supplies power to the information reading device when the second window has been selected to be opened, prevents power from being supplied to the photoelectric converter when the first window is closed, and prevents power from being supplied to the information reading device when the second window is closed.

8. The electronic camera of claim 7, further comprising:
a communication device that facilitates communication with external devices by transmitting the image information generated by the photoelectric converter to the external devices, and by receiving information transmitted from the external devices; and wherein:
the window generator generates, for display on the display, a third window relating to the communication device;
the window controller controls opening and closing of the third window; and
the power source controller supplies power to the communication device when the third window has been selected to be opened, and prevents power from being supplied to the communication device when the third window is closed.

9. The electronic camera of claim 8, further comprising:
an information processor that facilitates performance of information processing of information supplied from the external devices; and wherein:
the third window generated by the window generator also relates to the information processor; and
the power source controller supplies power to the information processor when the third window has been selected to be opened, and prevents power from being supplied to the information processor when the third window is closed.

10. The electronic camera of claim 7, further comprising:
an information processor that facilitates performance of information processing of information; and wherein:
the window generator also generates a third window relating to the information processor; and
the power source controller supplies power to the information processor when the third window has been selected to be opened, and prevents power from being supplied to the information processor when the third window is closed.

11. The electronic camera of claim 7, further comprising:
a communication device that facilitates communicating with external devices by transmitting information to the external devices and by receiving information transmitted from the external devices;
an information processor that facilitates performance of information processing of information; and wherein:
the window generator generates a third window relating to the communication device and to the information processor, and also generates user selection elements by which the communication device and the information processor can be selected;
the window controller controls opening and closing of the third window; and
the power source controller supplies power to the communication device when the user selection element relating to the communication device is selected, and supplies power to the information processor when the user selection element relating to the information processor is selected, the power source controller preventing power from being supplied to the communication device and to the information processor when their respective user selection elements are not selected.

12. The electronic camera of claim 7, further comprising:
an image recorder that records the image information generated by the photoelectric converter in the image recording medium; and wherein:
the first window also relates to the image recorder; and
the power source controller supplies power to the image recorder when the first window is selected to be opened, and prevents power from being supplied to the image recorder when the first window is closed.

13. An electronic camera comprising:
at least two functional portions that perform different operations;
a window generator that generates, for display on a display, a first window relating to an operation performed by a first one of the functional portions, a second window relating to an operation performed by a second one of the functional portions, and user selection elements by which a user can select opening and closing of the first and second windows;
an input device by which the user selection elements can be selected;
a window controller that controls opening and closing of the first window and of the second window based on the selection of the user selection elements by the input device; and
a power source controller that supplies power to the first functional portion when the first window has been selected to be opened, supplies power to the second functional portion when the second window has been selected to be opened, prevents power from being supplied to the first functional portion when the first window is closed, and prevents power from being supplied to the second functional portion when the second window is closed.

14. A method of controlling an electronic camera having at least two functional portions that perform different operations, comprising the steps of:
generating, for display on a display, a first window relating to a first one of the functional portions, a second window relating to a second one of the functional portions, and user selection elements by which a user can select opening and closing of the first and second windows;
receiving a selection command relating to one of the user selection elements;
controlling opening and closing of the first window and of the second window based on the selection command received relating to the user selection elements; and
controlling a supply of power by supplying power to the first functional portion when the first window has been selected to be opened, supplying power to the second functional portion when the second window has been selected to be opened, preventing power from being supplied to the first functional portion when the first window is closed, and preventing power from being supplied to the second functional portion when the second window is closed.

15. A method of controlling an electronic camera having a photoelectric converter that generates image information from an image of an object, and an information reading device that reads image information recorded in an image recording medium out of the image recording medium, the method comprising the steps of:
generating, for display on a display, a first window relating to an operation performed by the photoelectric converter, a second window relating to an operation performed by the information reading device, and user selection elements by which a user can select opening and closing of the first and second windows;
receiving a selection command relating to one of the user selection elements;
controlling opening and closing of the first window and of the second window based on the selection command; and
controlling the supply of power by supplying power to the photoelectric converter when the first window has been selected to be opened, supplying power to the information reading device when the second window has been selected to be opened, preventing power from being supplied to the photoelectric converter when the first window is closed, and preventing power from being supplied to the information reading device when the second window is closed.

16. The method of claim 15, wherein the electronic camera also includes a communication device that facilitates communication with external devices by transmitting the image information generated by the photoelectric converter to the external devices, and by receiving information transmitted from the external devices; the method further comprising:
generating, for display on the display, a third window relating to the communication device;
controlling opening and closing of the third window; and
controlling the supply of power by supplying power to the communication device when the third window has been selected to be opened, and preventing power from being supplied to the communication device when the third window is closed.

17. The method of claim 16, wherein the electronic camera also includes an information processor that facilitates performance of information processing of information supplied from the external devices, and the third window also relates to the information processor; the method further comprising:
controlling the supply of power by supplying power to the information processor when the third window has been selected to be opened, and preventing power from being supplied to the information processor when the third window is closed.

18. The method of claim 15, wherein the electronic camera also includes an information processor that facilitates performance of information processing of information, the method further comprising:
generating a third window relating to the information processor; and
controlling the power by supplying power to the information processor when the third window has been selected to be opened, and preventing power from being supplied to the information processor when the third window is closed.

19. The method of claim 15, wherein the electronic camera also includes a communication device that facilitates communicating with external devices by transmitting information to the external devices and by receiving information transmitted from the external devices, and an information processor that facilitates performance of information processing of information, the method further comprising:
generating a third window relating to the communication device and to the information processor, and also generating user selection elements by which the communication device and the information processor can be selected;
controlling opening and closing of the third window; and
controlling the supply of power by supplying power to the communication device when the user selection element relating to the communication device is selected, supplying power to the information processor when the user selection element relating to the information processor is selected, and preventing power from being supplied to the communication device and to the information processor when their respective user selection elements are not selected.

20. The method of claim 15, wherein the electronic camera also includes an image recorder that records the image information generated by the photoelectric converter in the image recording medium, and the first window also relates to the image recorder, the method further comprising:
controlling the supply of power by supplying power to the image recorder when the first window is selected to be opened, and preventing power from being supplied to the image recorder when the first window is closed.
